(19) United States
(12) Patent Application Publication
(10) Pub. No.: US 2003/0236825 A1
(43) Pub. Date: Dec. 25, 2003

(54) System, method and computer readable medium for transferring and rendering a web page

(76) Inventor: Suhas Sudhakar Kulkarni, Maharashtra (IN)

Correspondence Address: HEWLETT-PACKARD COMPANY, Intellectual Property Administration, P.O. Box 272400, Fort Collins, CO, 80527-2400, US

(21) Appl. No.: 10/177,486

(22) Filed: Jun. 20, 2002

(51) Int. Cl. G06F 15/16

(52) U.S. Cl. 709/203

(57) ABSTRACT

A method of transferring a file which contains data that partially defines a page from a first computer in a computer network to a second computer for rendering the page thereon is disclosed. Data representing at least one component of the page is preloaded on a local store of the second computer. The file is downloaded onto the second computer in response to a request on the second computer. This file also contains a reference to the preloaded data. The second computer retrieves the preloaded data from the local store of the second computer using the reference and renders the page on the second computer using data in the downloaded file and the retrieved data.

### BACKGROUND

This invention relates to the World Wide Web, and more particularly, to a system and a method for transferring a file defining a Web page from a server computer (server hereinafter) to a client computer (client hereinafter) for rendering on the client.

The worldwide network of computers commonly known as the Internet has seen explosive growth. This growth has been fueled mainly by the introduction and widespread use of web browsers, which allow for simple graphical user interface (GUI)-based access to network servers that support documents, more commonly known as Web pages. The World Wide Web (WWW) is the collection of servers of the Internet that utilizes the Hypertext Transfer Protocol (HTTP). HTTP is a known application protocol that provides user access to files (which can be in different formats such as text, graphics, images, sound, video, etc.) using a standard page description language known as the Hypertext Markup Language (HTML). HTML provides basic document formatting and allows specifications of “links” to other servers and files. Use of an HTML-compliant client browser involves specification of a link to a server via a Uniform Resource Locator (URL). Upon such specification, the client makes a Transmission Control Protocol/Internet Protocol (TCP/IP) request to the server and receives a Web page from the server in return.

Many Web pages typically include at least one component that is an image or some type of multimedia. Data representing the component is usually stored in a separate file at the server and is transferred from the server to the client when requested in order for the complete Web page to be rendered at the client. Transfer of such a file from the server to the client can be time-consuming, especially when the file is large. Such a transfer also increases the traffic on the Internet.

To reduce this traffic, files defining a Web page are stored in a local cache of the client after the Web page is received. When the Web page is revisited, the browser gets the files from the cache rather than the original server. Consequently the Web page loads more quickly than the first time the page is accessed. However the cache provides only a temporary storage for the files.

### SUMMARY

According to an aspect of the present invention, there is provided a method of transferring a file which contains data that partially defines a page from a first computer in a computer network to a second computer for rendering the page thereon. Data representing at least one component of the page is preloaded on a local store of the second computer. The file is downloaded onto the second computer in response to a request on the second computer. This file contains a reference to the preloaded data. The second computer retrieves the preloaded data from the local store of the second computer using the reference and renders the page on the second computer using data in the downloaded file and the retrieved data.

According to another aspect of the present invention, there is provided a system for transferring a file which contains data that partially defines a page and for rendering the page. The system includes a client and a server. The client holds preloaded data representing at least one component of the page stored in a local store of the client. The server holds the file that also contains a reference to the preloaded data. In use, the client downloads the file from the server in response to a request on the client, parses this file, retrieves the preloaded data and renders the page using the data in the file and the retrieved data.

According to yet another aspect of the present invention, there is provided a program storage device readable by a computing device, tangibly embodying a program of instructions, executable by the computing device to perform the above-described method of transferring a file which contains data that partially defines a page from a first computer in a computer network to a second computer for rendering the page thereon.

### BRIEF DESCRIPTION OF DRAWINGS

The invention will be better understood with reference to the drawings, in which:

FIG. 1 is a diagram of an Internet environment including at least a client and a server having an embodiment of the present invention;

FIG. 2 is a block diagram of elements of a computing device that may be used to perform the functions of the client and the server in FIG. 1; and

FIG. 3 is a sequence of steps for transferring a Web page from the server to the client in FIG. 1 for rendering on the client.

### DETAILED DESCRIPTION

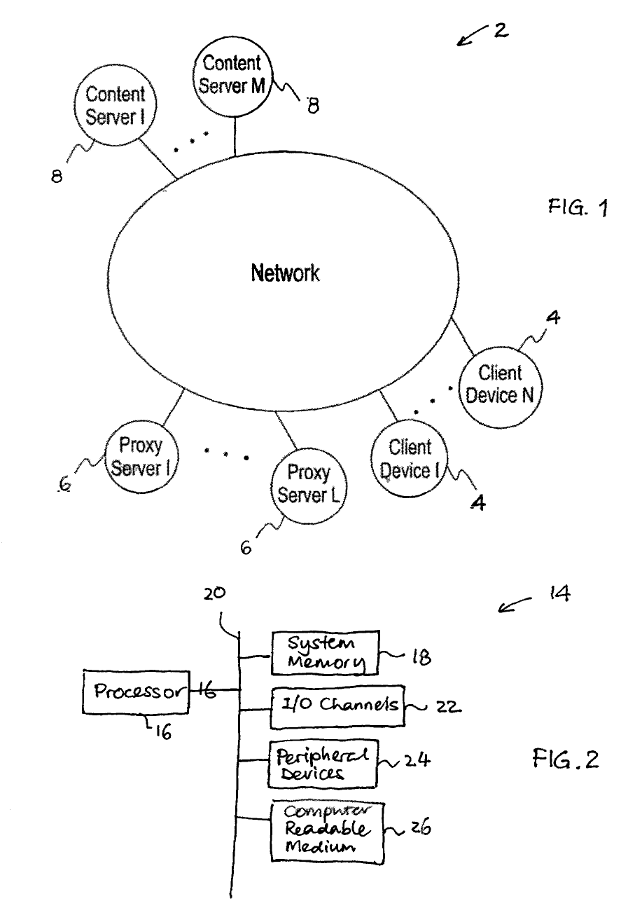

FIG. 1 shows an example of an Internet environment 2 wherein an embodiment of the present invention may be implemented. The Internet environment 2 includes client devices 4, proxy servers 6 and content servers 8. The Internet allows easy access to services such as electronic mail, internet relay chats, real time voice conversations and to a wealth of information on what has come to be known as the World Wide Web (WWW) or the Web for short. The WWW is defined by all the resources and users on the Internet that are using the Hypertext Transfer Protocol (HTTP). A client 4 depends on one of the servers 6, 8 to deliver information. Typically, the client 4 is a local personal computer (PC) while the server 6, 8 is usually a more powerful computer that houses the data.

More specifically, the client 4 is a browser application on the PC and the server 6, 8 is a host computer located somewhere on the Internet. The Microsoft Internet Explorer and the Netscape Navigator are two of the more popular browsers available. When used, the browser sends a request for a specific Web page to the server 6, 8 over an established connection. The server 6, 8 processes or answers that request and sends data defining the Web page back to the browser. The connection between the client 4 and the server 6, 8 is maintained only while the exchange of information is being transacted. Thus, after the data defining a Web page is transferred from the server 6, 8, the HTTP connection between the server 6, 8 and the client 4 is terminated.

According to an embodiment of the present invention, the Web page is defined by data in a file notated using the Hypertext Markup Language (HTML). Usually, the file contains text and specifications about where images or other multimedia files are to be placed when the page is rendered or displayed. The images and multimedia files may include components such as buttons, backdrops, static Graphic Interchange Format (GIF) files, moving GIF files, electronic forms, scripts, company logos, maps, pictures of famous personalities, calendar, other animations, photographs, cliparts, cartoons and other frequently accessed information. Unlike the prior art where the image and multimedia files are stored on a server 6, 8, the images and multimedia files are preloaded on the clients 4.

More information regarding the WWW may be found in the book, “How the World Wide Web Works,” by Chris Shipley and Matthew Fish, published by Ziff-Davis Press.

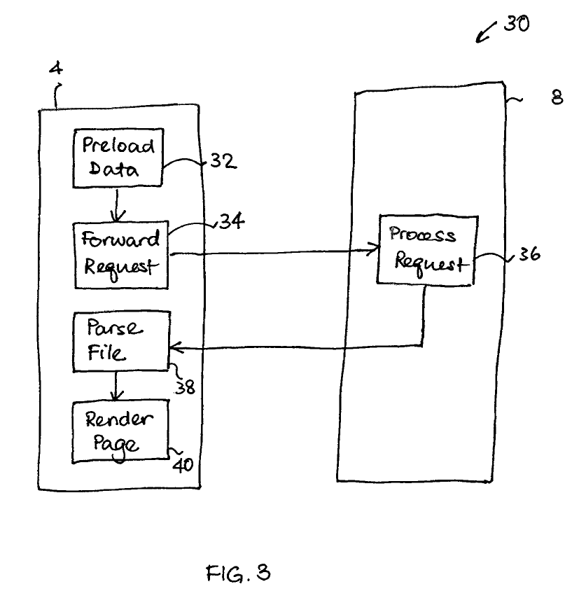

FIG. 2 is a block diagram illustrating typical elements of a computing device 14 that may be appropriately programmed to function as a client 4 or a server 6, 10 of FIG. 1. The elements include a programmable processor 16 connected to a system memory 18 via a system bus 20. The processor 16 accesses the system memory 18 as well as other input/output (I/O) channels 22 and peripheral devices 24. The computing system 14 further includes at least one computer readable medium 26, such as a CD-ROM, tape, magnetic media, EPROM, EEPROM, ROM or the like. The computing device 14 stores one or more computer programs that implement a method of transferring and rendering a Web page according to an embodiment of the present invention. The processor 16 reads and executes the one or more computer programs to perform the method. Each of the computer programs may be implemented in any desired computer programming language (including machine, assembly, high level procedural, or object oriented programming languages). In any case, the language may be a compiled or interpreted language.

FIG. 3 is a flowchart showing a sequence 30 of steps for transferring a file containing data that partially defines a Web page from a first computer to a second computer for rendering the Web page thereon. The sequence 30 starts in a PRELOAD DATA step 32 at the client 4, wherein a file containing data representing at least one component suitable for rendering on a Web page is preloaded onto a local store, such as a hard disk drive (not shown), of the client 4. The sequence 30 next proceeds to a FORWARD REQUEST step 34 at the client 4, wherein the client 4 receives and forwards a request for a specific Web page to the server 8. The sequence then proceeds to a PROCESS REQUEST step 36 at the server 8, wherein the server 8 processes or answers the request by downloading a file which contains data that partially defines the requested Web page to the client 4. This file contains a reference to the preloaded component. An example of such a reference is given in the HTML statement below:

<a href=http://www.l23abcd.com/example.html> <img SRC
=“$COMPONENT-PATH/buttons/button1.gif” height=20
width=104> </a>

The portion of the statement, $COMPONENT-PATH/buttons/button1.gif, gives the full pathname on the client 4 where the file containing image data of the component, in this case a button, button1, is located. $COMPONENT-PATH is an environment variable that is user-configurable. Alternatively, the environment variable may be named $STANDARD-PERMANENT-BROWSER-CACHE-PATH or $SPBC-PATH for short.

The sequence 30 next proceeds to a PARSE FILE step 38 at the client 4, wherein the browser on the client 4 parses the file received from the server 8. When the above HTML statement in the file is parsed, the browser recognizing the environment variable $COMPONENT-PATH retrieves the preloaded data of the component from the local store of the client 4. Unlike in the prior art, the client 4 does not separately request the image file from the server 8. The sequence 30 finally ends in a RENDER PAGE step 40, wherein the browser renders the Web page using data in the file and the retrieved data. The browser simply renders the component by displaying the graphic image if the component is a graphic image.

If the component is an audio component, coded for example as a RealAudio (a streaming sound technology available from Progressive Networks Inc.) audio stream, the browser renders the audio component by enlisting the help of a RealAudio player on the client 4 to play the audio stream. If the component is an animation sequence, pages that make up the animation sequence are locally stored on the client 4. The browser renders the component by displaying one page following another when the time interval between the two pages has elapsed.

The World Wide Web Consortium may adopt the components as standard components that are bundled and installed with browsers. Alternatively, the components may be made available as add-ons that can be installed on the clients 4 separately from the installation of the browsers. With standardization, data for the components may be stored in a predetermined client directory instead of a user-configurable one as described above. Ideally, a WWW usage survey should be conducted before a collection of standard components is defined and created.

Advantageously, the method described above provides a better response time than does the prior art method because not all data of a Web page needs to be loaded from a server. Data of frequently used components are made available locally on the client. Such locally available data reduces traffic on the Internet to result in more available bandwidth on the Internet. If the components are adopted as a standard, users of the WWW may be presented with a common look-and-feel user interface that may over time become more intuitive to a user.

Although the present invention is described as implemented in the above-described embodiment, it is not to be construed to be limited as such. For example, the data representing a Web page may also be coded using the Extensible Markup Language (XML) instead of HTML.

As another example, the invention may not be limited to implementation on the Internet with standardized components. The invention may be implemented on an Intranet or even on a single client-server pair with mutually agreed upon components that are resident on the client.

As a further example, the server 8 may determine if the client 4 has locally resident components before downloading the appropriate Web pages to the client 4.

I claim:

1. A method of transferring a file which contains data that partially defines a page from a first computer in a computer network to a second computer for rendering the page thereon, the method comprising:
preloading data representing at least one component of the page on a local store of the second computer;
downloading the file which also contains a reference to the preloaded data in response to a request on the second computer;
retrieving the preloaded data from the local store of the second computer using the reference; and
rendering the page on the second computer using the data in the file and the retrieved data.

2. A method according to claim 1, wherein the component includes a standardized component adopted across the computer network.

3. A method according to claim 2, wherein the component is bundled and installed with a browser on the second computer and wherein the browser renders the page.

4. A method according to claim 2, wherein the component is available as an add-on component that is separately installable from installation of a browser on the second computer.

5. A method according to claim 2, wherein preloading data includes preloading data representing at least one component of the page on a local store of the second computer, wherein the component is determined according to its usage on the World Wide Web.

6. A method according to claim 1, wherein the component is stored in a predetermined directory of the local store.

7. A method according to claim 1, wherein the component is stored in a user-configurable directory of the local store, the user-configurable directory being accessible using an environment variable on the second computer.

8. A method according to claim 1, wherein the component includes images and multimedia information.

9. A method according to claim 1, further comprising adopting the component as a standardized component across the computer network.

10. A system for transferring a file containing data that partially defines a page for rendering comprising:
a client that holds preloaded data representing at least one component of the page stored in a local store of the client; and
a server that holds the file which also contains a reference to the preloaded data;
wherein in use the client downloads the file from the server in response to a request on the client, parses the file, retrieves the preloaded data and renders the page using data in the file and the preloaded data.

11. A program storage device readable by a computing device, tangibly embodying a program of instructions, executable by the computing device to perform the method of transferring a file which contains data that partially defines a page from a first computer in a computer network to a second computer for rendering the page thereon, the method comprising:
preloading data representing at least one component of the page on a local store of the second computer;
downloading the file which also contains a reference to the preloaded data in response to a request on the second computer;
retrieving the preloaded data from the local store of the second computer using the reference; and
rendering the page on the second computer using the data in the file and the retrieved data.
